(19) United States
(12) Patent Application Publication
(10) Pub. No.: US 2006/0164608 A1
(43) Pub. Date: Jul. 27, 2006

(54) Projection optical system

(75) Inventors: Hung-Wen Liu, Taoyuan (TW); Chun-Ming Shen, Taoyuan (TW); Jung-Yao Chen, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/336,117

(22) Filed: Jan. 20, 2006

(30) Foreign Application Priority Data
Jan. 25, 2005 (TW) 094102078

(51) Int. Cl. G03B 21/14

(52) U.S. Cl. 353/97

(57) ABSTRACT

A projection optical system includes an illumination system, a first adjusting device for adjusting an aperture size of the illumination system, a projection lens, a second adjusting device for adjusting an aperture size of the projection lens, and a controller. According to a look-up table or a predetermined calculation equation, the controller is used for controlling the second adjusting device and the first adjusting device to synchronously adjust the aperture size of the projection lens and the aperture size of the illumination system.

### BACKGROUND OF THE INVENTION

1. Field of the Invention

The present invention relates to a projection optical system, and more particularly to a projection optical system capable of synchronously adjusting an aperture size of a projection lens and an aperture size of an illumination system, so as to improve the contrast ratio of the projection optical system.

2. Description of the Prior Art

Referring to FIG. 1, FIG. 1 is a schematic diagram illustrating a projection optical system 10 of the prior art. The projection optical system 10 includes a light source 12, an integration rod 14, an illumination system 16, a digital mocromirror device (DMD) 18, a projection lens 20, and a screen 22. By means of the projection optical system 10 mentioned above, a light beam is transmitted from the light source 12 into the illuminating system 16 through the integration rod 14. Then, the light beam is transmitted into the projection lens 20 after being reflected from the DMD 18 in order to project an image on the screen 22.

In general, the projected image quality is related to the contrast ratio of the projection optical system. The contrast ratio means the ratio of highest light output to the lowest light output on the screen. If the contrast ratio is higher, the image will be clearer, otherwise the image will be vague. As shown in FIG. 1, the contrast ratio is always influenced by the aperture size 200 of the projection lens 20 and the aperture size 160 of the illumination system 16. In other words, when the aperture size 200 of the projection lens 20 changes, the aperture size 160 of the illumination system 16 also needs to be adjusted to generate an optimal contrast ratio. However, the projection optical system 10 of the prior art cannot synchronously adjust the aperture size 200 of the projection lens 20 and the aperture size 160 of the illumination system 16, so the theater mode performed via the projection optical system 10 is limited.

Therefore, the objective of the present invention is to provide a projection optical system capable of synchronously adjusting the aperture size of the projection lens and the aperture size of the illumination system, so as to solve the above-mentioned problems.

### SUMMARY OF THE INVENTION

The objective of the present invention is to provide a projection optical system capable of synchronously adjusting the aperture size of the projection lens and the aperture size of the illumination system, so as to improve the contrast ratio. Accordingly, the projection optical system can be adapted to different requirement.

According to the present invention, the projection optical system includes an illumination system, a first adjusting device, a projection lens, a second adjusting device, and a controller. The illumination system has a first front end. The first adjusting device is disposed at the first front end and adjacent to the aperture stop of the illumination lens. The first adjusting device is used for adjusting an aperture size of the illumination lens. The second adjusting device is disposed between the illumination system and the projection lens and adjacent to the projection lens. The second adjusting device is used for adjusting an aperture size of the projection lens to be equal to a current aperture size. The controller is electrically coupled to the first adjusting device and the second adjusting device respectively. According to a look-up table or a predetermined equation, the controller controls the second adjusting device and the first adjusting device to synchronously adjust the aperture size of the projection lens and the aperture size of the illumination system.

Therefore, according to the projection optical system of the present invention, when the aperture size of the projection lens or the aperture size of the illumination system changes, the controller will synchronously adjust the aperture size of the illumination system or the aperture size of the projection lens, so as to generate an optimal contrast ratio for different requirement.

The advantage and spirit of the invention may be understood by the following recitations together with the appended drawings.

### BRIEF DESCRIPTION OF THE APPENDED DRAWINGS

FIG. 1 is a schematic diagram illustrating a projection optical system of the prior art.

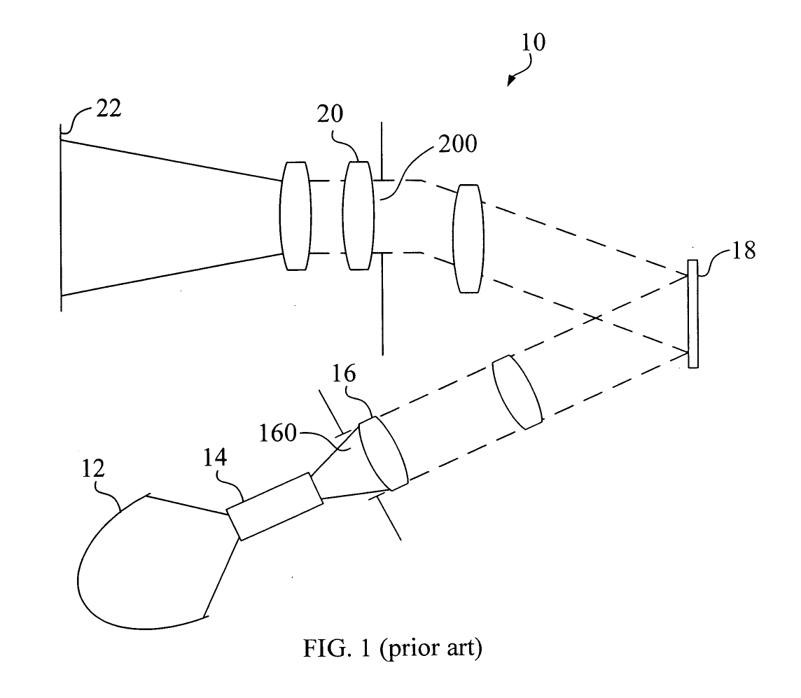

FIG. 2 is a functional block diagram illustrating a projection optical system according to a preferred embodiment of the present invention.

FIG. 3 is an outside view illustrating the illumination system and the first adjusting device shown in FIG. 2.

FIG. 4 is a front view illustrating the projection lens and the second adjusting device shown in FIG. 2.

FIG. 5 is a schematic diagram illustrating the look-up table shown in FIG. 2.

FIG. 6 is a front view illustrating the illumination system and the first adjusting device according to another preferred embodiment of the present invention.

FIG. 7 is an outside view illustrating the projection lens and the second adjusting device according to another preferred embodiment of the present invention.

### DETAILED DESCRIPTION OF THE INVENTION

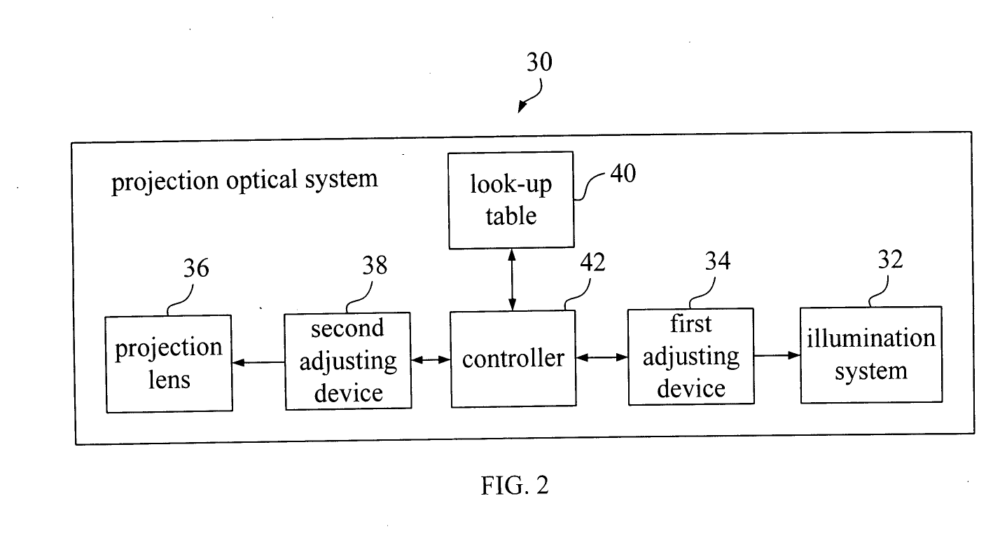

Referring to FIG. 2, FIG. 2 is a functional block diagram illustrating a projection optical system 30 according to a preferred embodiment of the present invention. The projection optical system 30 includes an illumination system 32, a first adjusting device 34, a projection lens 36, a second adjusting device 38, a look-up table 40, and a controller 42. The second adjusting device 38 is disposed between the illumination system 32 and the projection lens 36.

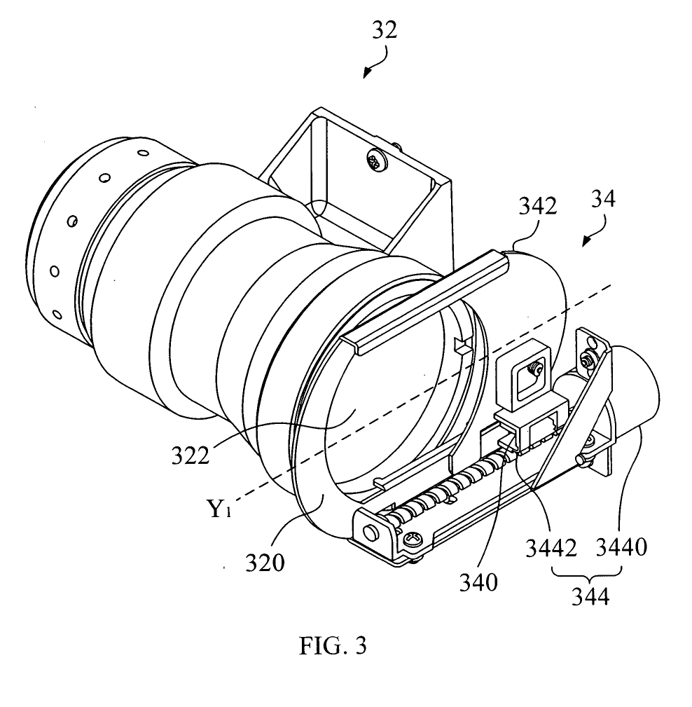

Referring to FIG. 3, FIG. 3 is an outside view illustrating the illumination system 32 and the first adjusting device 34 shown in FIG. 2. The illumination system 32 has a first front end 320 close to the stop thereof. The first adjusting device 34 is disposed at and adjacent to the first front end 320 of the illumination system 32 and used for adjusting an aperture size 322 of the illumination system 32. A first horizontal axis Y, is defined ahead of the illumination system 32. In this embodiment, the first adjusting device 34 includes a first base 340, a first shield 342, and a first actuator 344. The first base 340 is movable along the first horizontal axis Y.. The first actuator 344 includes a first motor 3440 and a rotatable first screw rod 3442. The first shield 342 is mounted onto the first base 340 and used for selectively shielding the aperture 322 of the illumination system 32. In this embodiment, the shape of the first shield 342 is substantially arc. The first screw rod 3442 is rotatably mounted onto the first base 340 and driven by the first motor 3440 to actuate the first base 340, so as to tune the position of the first base 340 along the first horizontal axis Y₁. The aperture size 322 of the illumination system 32 is equal to an area of the part of the illumination system 32 not shielded by the first shield 342 yet.

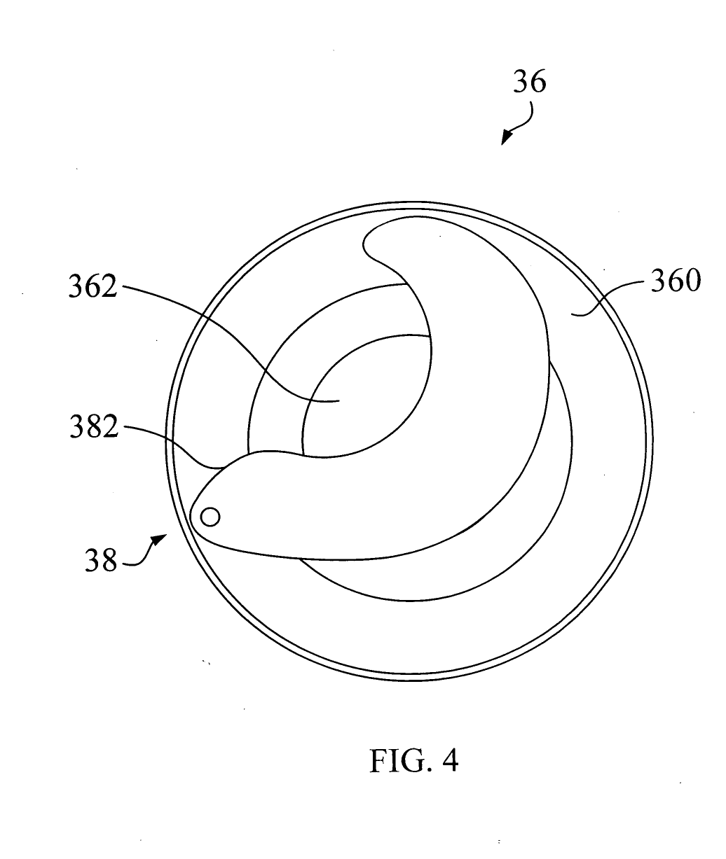

Referring to FIG. 4, FIG. 4 is a front view illustrating the projection lens 36 and the second adjusting device 38 shown in FIG. 2. The second adjusting device 38 is adjacent to the projection lens 36 and close to the stop of the projection lens 36. The second adjusting device 38 is used for adjusting an aperture size 362 of the projection lens 36 to be equal to a current aperture size. The projection lens 36 has a second front end 360. The second adjusting device 38 includes a second shield 382 and a second actuator (not shown). The second actuator includes a second motor (not shown). The second shield 382 is pivotally mounted onto the second front end 360 of the projection lens 36 and used for selectively shielding the aperture 362 of the projection lens 36. The shape of the second shield 382 is substantially iris-shaped or arc. In this embodiment, the shape of the second shield 382 is iris-shaped. The aperture size 362 of the projection lens 36 is equal to an area of the part of the projection lens 36 not shielded by the second shield 382 yet.

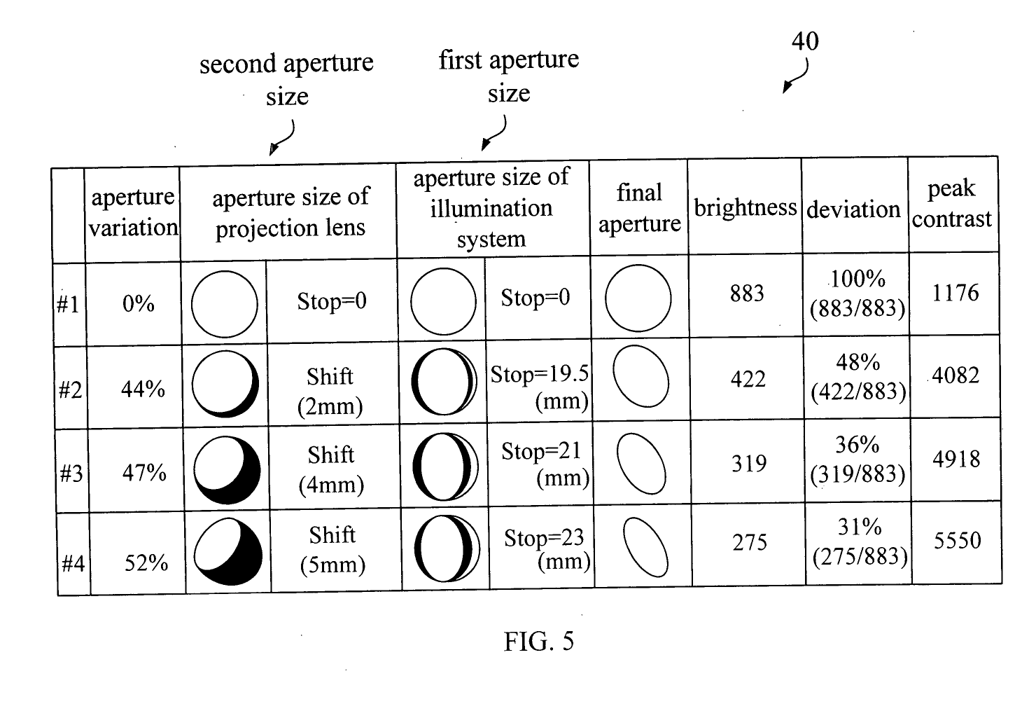

Referring to FIG. 5, FIG. 5 is a schematic diagram illustrating the look-up table 40 shown in FIG. 2. The look-up table 40 is used for storing N first aperture sizes relative to the aperture size 322 of the illumination system 32 and N second aperture sizes relative to the aperture size 362 of the projection lens 36. Each of the N first aperture sizes corresponds to one of the N second aperture sizes, wherein N is a natural number. In this embodiment, the look-up table 40 respectively stores four first aperture sizes relative to the aperture size 322 of the illumination system 32 and four second aperture sizes relative to the aperture size 362 of the projection lens 36, as shown in FIG. 5.

Referring to FIG. 2 again, the controller 42 is electrically coupled to the first adjusting device 34, the second adjusting device 38, and the look-up table 40 respectively. The controller 42 is used for controlling the second adjusting device 38 and the first adjusting device 34 to synchronously adjust the aperture size 362 of the projection lens 36 and the aperture size 322 of the illumination system 32. In this embodiment, when the controller 42 detects the aperture size 362 of the projection lens 36, the controller 42 will search one of the four second aperture sizes from the look-up table 40 according to the detected aperture size 362 of the projection lens 36. Afterward, the controller 42 accesses one of the four first aperture sizes from the look-up table 40 corresponding to the searched second aperture size and controls the first adjusting device 34 to adjust the aperture size 322 of the illumination system 32 to be equal to the accessed first aperture size. On the other hand, when the controller 42 detects the aperture size 322 of the illumination system 32, the controller 42 will search one of the four first aperture sizes from the look-up table 40 according to the detected aperture size 322 of the illumination system 32. Afterward, the controller 42 accesses one of the four second aperture sizes from the look-up table 40 corresponding to the searched first aperture size and controls the second adjusting device 38 to adjust the aperture size 362 of the projection lens 36 to be equal to the accessed second aperture size. Accordingly, when the aperture size 362 of the projection lens 36 or the aperture size 322 of the illumination system 32 changes, according to the look-up table 40, the controller 42 will synchronously adjust the aperture size 322 of the illumination system 32 or the aperture size 362 of the projection lens 36, so as to generate an optimal contrast ratio for different requirement.

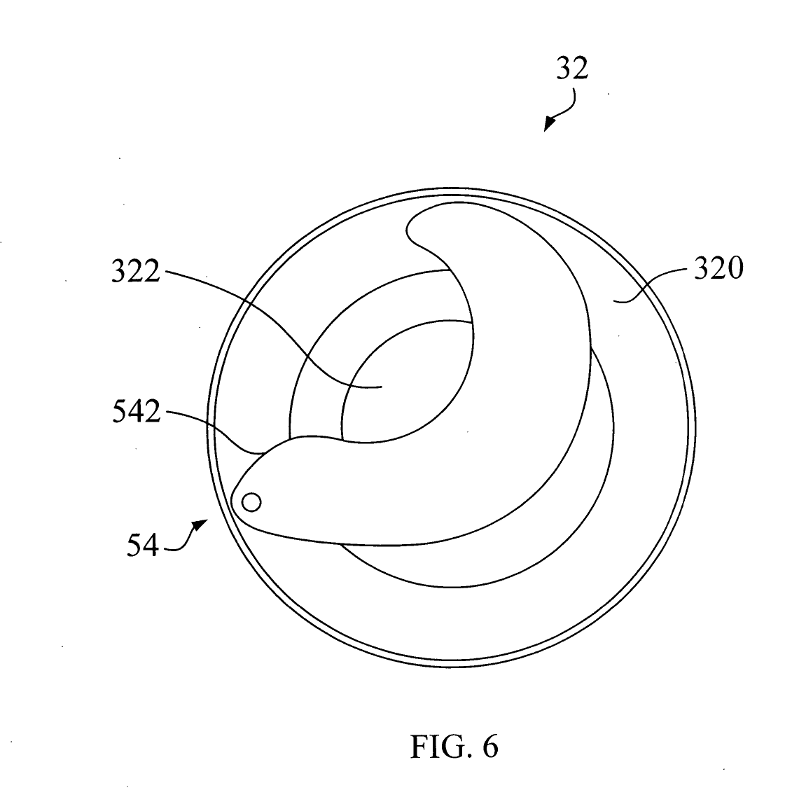

Referring to FIG. 6, FIG. 6 is a front view illustrating the illumination system 32 and the first adjusting device 54 according to another preferred embodiment of the present invention. The illumination system 32 has a first front end 320. The first adjusting device 54 includes a first shield 542 and a first actuator (not shown). The first actuator includes a first motor (not shown). The first shield 542 is pivotally mounted onto the first front end 320 of the illumination system 32 and used for selectively shielding the aperture 322 of the illumination system 32. In this embodiment, the shape of the first shield 542 is iris-shaped. The aperture size 322 of the illumination system 32 is equal to an area of the part of the illumination system 32 not shielded by the first shield 542 yet.

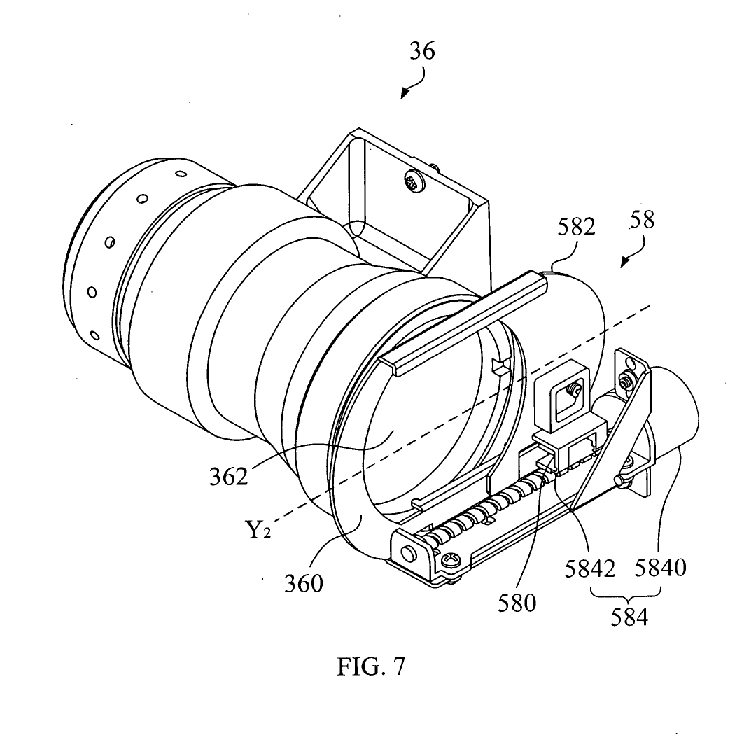

Referring to FIG. 7, FIG. 7 is an outside view illustrating the projection lens 36 and the second adjusting device 58 according to another preferred embodiment of the present invention. The projection lens 36 has a second front end 360. The second adjusting device 58 is disposed at and adjacent to the second front end 360 of the projection lens 36 and used for adjusting an aperture size 362 of the projection lens 36. A second horizontal axis Y₂ is defined ahead of the projection lens 36. In this embodiment, the second adjusting device 58 includes a second base 580, a second shield 582, and a second actuator 584. The second base 580 is movable along the second horizontal axis Y₂. The second actuator 584 includes a second motor 5840 and a rotatable second screw rod 5842. The second shield 582 is mounted onto the second base 580 and used for selectively shielding the aperture 362 of the projection lens 36. In this embodiment, the shape of the second shield 582 is substantially arc. The second screw rod 5842 is rotatably mounted onto the second base 580 and driven by the second motor 5840 to actuate the second base 580, so as to tune the position of the second base 580 along the second horizontal axis Y₂. The aperture size 362 of the projection lens 36 is equal to an area of the part of the projection lens 36 not shielded by the second shield 582 yet.

For practical application, different first adjusting device and second adjusting device can be adopted respectively for different requirement.

According to another preferred embodiment of the present invention, the look-up table 40 shown in FIG. 2 can be replaced by a predetermined equation. When the aperture size of the projection lens changes, the controller will synchronously adjust the aperture size of the illumination system according to the predetermined equation. On the other hand, when the aperture size of the illumination system changes, the controller will also synchronously adjust the aperture size of the projection lens according to the predetermined equation.

Compared to the prior art, according to the projection optical lens of the present invention, when the aperture size of the projection lens or the aperture size of the illumination system changes, the controller will synchronously adjust the aperture size of the illumination system or the aperture size of the projection lens, so as to generate an optimal contrast ratio for different requirement.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A projection optical system comprising:
an illumination system;
a first adjusting device for adjusting an aperture size of the illumination system;
a projection lens;
a second adjusting device for adjusting an aperture size of the projection lens; and
a controller for controlling the second adjusting device and the first adjusting device to synchronously adjust the aperture size of the projection lens and the aperture size of the illumination system.

2. The projection optical system of claim 1, further comprising a look-up table for storing N first aperture sizes relative to the aperture size of the illumination system and N second aperture sizes relative to the aperture size of the projection lens, each of the N first aperture sizes corresponding to one of the N second aperture sizes, N being a natural number.

3. The projection optical system of claim 2, wherein the controller detects the current aperture size of the projection lens, accesses, according to the detected aperture size of the projection lens, one from the N first aperture sizes stored in the look-up table, and controls the first adjusting device to adjust the aperture size of the illumination system to be equal to the accessed first aperture size.

4. The projection optical system of claim 2, wherein the controller detects the current aperture size of the illumination system, accesses, according to the detected aperture size of the illumination system, one from the N second aperture sizes stored in the look-up table, and controls the second adjusting device to adjust the aperture size of the projection lens to be equal to the accessed second aperture size.

5. The projection optical system of claim 1, wherein the controller synchronously adjusts the aperture size of the projection lens and the aperture size of the illumination system according to a predetermined equation.

6. The projection optical system of claim 1, wherein the first adjusting device comprises:
a first shield for selectively shielding the illumination system;
wherein the aperture size of the illumination system is equal to an area of the part of the illumination system not shielded by the first shield yet.

7. The projection optical system of claim 6, wherein a first horizontal axis is defined ahead of a first front end of the illumination system, and the first adjusting device further comprises:
a first base being movable along the first horizontal axis, and the first shield being mounted onto the first base; and
a first actuator, connected to the first base, for actuating the first base to tune the position of the first base along the first horizontal axis.

8. The projection optical system of claim 7, wherein the first actuator comprises a first motor and a rotatable first screw rod driven by the first motor.

9. The projection optical system of claim 6, wherein the first shield is pivotally mounted onto a first front end of the illumination system.

10. The projection optical system of claim 9, wherein the first adjusting device further comprises:
a first actuator, connected to the first shield, for actuating the first shield to rotate.

11. The projection optical system of claim 10, wherein the first actuator comprises a first motor.

12. The projection optical system of claim 6, wherein the first shield is substantially iris-shaped or arc.

13. The projection optical system of claim 1, wherein the second adjusting device comprises:
a second shield for selectively shielding the projection lens;
wherein the aperture size of the projection lens is equal to an area of the part of the projection lens not shielded by the second shield yet.

14. The projection optical system of claim 13, wherein a second horizontal axis is defined ahead of a second front end of the projection lens, and the second adjusting device further comprises:
a second base being movable along the second horizontal axis, and the second shield being mounted onto the second base; and
a second actuator, connected to the second base, for actuating the second base to tune the position of the second base along the second horizontal axis.

15. The projection optical system of claim 14, wherein the second actuator comprises a second motor and a rotatable second screw rod driven by the second motor.

16. The projection optical system of claim 13, wherein the second shield is pivotally mounted onto a second front end of the projection lens.

17. The projection optical system of claim 16, wherein the second adjusting device further comprises:
a second actuator, connected to the second shield, for actuating the second shield to rotate.

18. The projection optical system of claim 17, wherein the second actuator comprises a second motor.

19. The projection optical system of claim 13, wherein the second shield is substantially iris-shaped or arc.
